(19) United States
(12) Patent Application Publication
(10) Pub. No.: US 2019/0043487 A1
(43) Pub. Date: Feb. 7, 2019

(54) METHODS AND SYSTEMS FOR OPTIMIZING ENGINE SELECTION USING MACHINE LEARNING MODELING

(71) Applicant: Veritone, Inc., Newport Beach, CA (US)

(72) Inventor: Steven Neal Rivkin, Laguna Niguel, CA (US)

(21) Appl. No.: 15/922,802

(22) Filed: Mar. 15, 2018

Related U.S. Application Data
(60) Provisional application No. 62/638,745, filed on Mar. 5, 2018.
(60) Provisional application No. 62/633,023, filed on Feb. 20, 2018.
(60) Provisional application No. 62/540,508, filed on Aug. 2, 2017.

(51) Int. Cl. G10L 15/16; G06N 3/08; G10L 15/30

(52) U.S. Cl. CPC G10L 15/16; G10L 15/30; G06N 3/08

(57) ABSTRACT

A system for optimizing selection of transcription engines using a combination of selected machine learning models. The system includes a plurality of preprocessors that generate a plurality of features from a media data set. The system further includes a deep learning neural network model, a gradient boosted machine model and a random forest model used in generating a ranked list of transcription engines. A transcription engine is selected from the ranked list of transcription engines to generate a transcript for the media dataset.

### CROSS-REFERENCE TO RELATED APPLICATION

This application claims priority to U.S. Provisional Application No. 62/638,745, filed Mar. 5, 2018, U.S. Provisional Application No. 62/633,023, filed Feb. 20, 2018, and U.S. Provisional Application No. 62/540,508, filed Aug. 2, 2017, each of which are hereby incorporated in their entirety by reference.

### TECHNICAL FIELD

The claimed invention relates to optimizing engine selection, and in some aspects to methods and systems for optimizing the selection of transcription and/or object recognition engines using machine learning modeling.

### BACKGROUND

Since the advent of the Internet and the video-recording-enabled smartphone, a massive amount of multimedia is being generated every day. For example, because people can record live events with ease and simplicity, new multimedia (e.g., music and/or videos) are constantly being generated. There is also ephemeral media, such as radio broadcasts. Once these media are created, there is no existing technology to optimally transcribe all of the content therein. It is estimated that about 80% of the world data is unreadable by machines.

Accordingly, there is a need for methods and systems to ingest the massive amount of media being generated and transform them into searchable and actionable data, particularly methods and systems for optimizing the selection of transcription engines using a combination of data processing modules and machine learning models.

### SUMMARY

Provided herein are embodiments of systems and methods for optimizing the selection of transcription engines using a combination of selected machine learning models. In some embodiments, the system includes a database storing one or more media data sets, and one or more preprocessors configured to generate a plurality of features from a selected media data set of the media data sets. The system further includes a deep learning neural network model configured to improve detection of the patterns in the features and to improve generation of classified categories, a gradient boosted machine model configured to improve the prediction of patterns in the features and to improve the generation of multiclass classified categories, a random forest model configured to improve the prediction of patterns in the classification data and to improve generation of multiclass classified categories. A ranked list of transcription engines are generated based on learning from the deep learning neural network model, the gradient boosted machine model, and the random forest model. Then a transcription engine, selected from the ranked list of transcription engines, ingests the features and generates a transcript for the selected media data set.

In some embodiments, the preprocessors may include an alphanumeric preprocessor, an audio analysis preprocessor, a categorical preprocessor, and a continuous variable preprocessor.

In some embodiments, when all three machine learning models are used, a multi-model stacking model is created from a combination of results generated from the three machine learning models.

In some embodiments, the system includes one or more multinomial accuracy modules configured to reduce bias and variance in the model predictions and each multinomial accuracy module generates a confusion matrix.

In some embodiments, the database is a temporal elastic database.

Other features and advantages of the present invention will be or will become apparent to one with skill in the art upon examination of the following figures and detailed description, which illustrate, by way of examples, the principles of the present invention.

### BRIEF DESCRIPTION OF THE DRAWINGS

The present invention may be better understood by referring to the following figures. The components in the figures are not necessarily to scale, emphasis instead being placed upon illustrating the principles of the disclosure. In the figures, like reference numerals designate corresponding parts throughout the different views.

FIG. 1 illustrates a high-level flow diagram depicting a process for optimizing the selection of transcription engines using a combination of selected preprocessors, according to some aspects of the disclosure.

FIG. 2A illustrates a high-level block diagram showing a training process and a production process, according to some aspects of the disclosure.

FIG. 2B illustrates an exemplary detailed process flow of a training process, according to some aspects of the disclosure.

FIG. 2C illustrates an exemplary flow diagram illustrating a first portion of a transcription engine selection optimization production process, according to some aspects of the disclosure.

FIG. 2D illustrates an exemplary flow diagram illustrating a second portion of a transcription engine selection optimization production process, according to some aspects of the disclosure.

FIG. 2E illustrates an exemplary transcript segment of an output transcript, according to some aspects of the disclosure.

FIG. 3A illustrates exemplary flow diagrams showing a first portion of a process for optimizing the selection of transcription engines using a combination of selected preprocessors, according to some aspects of the disclosure.

FIG. 3B illustrates exemplary flow diagrams showing a second portion of a process for optimizing the selection of transcription engines using a combination of selected preprocessors, according to some aspects of the disclosure.

FIG. 3C illustrates exemplary flow diagrams showing a third portion of a process for optimizing the selection of transcription engines using a combination of selected preprocessors, according to some aspects of the disclosure.

FIG. 3D illustrates an exemplary modeling process using machine learning algorithms, according to some aspects of the disclosure.

FIG. 3D-1 illustrates an exemplary confusion matrix, according to some aspects of the disclosure.

FIGS. 3D-1A and 3D-1B illustrate an exemplary modeling process using deep learning neural network, according to some aspects of the disclosure.

FIG. 3D-2 illustrates an exemplary modeling process using gradient boosted machines, according to some aspects of the disclosure.

FIG. 3D-3 illustrates an exemplary modeling process using random forests, according to some aspects of the disclosure.

FIG. 3D-4 illustrates an exemplary modeling process using a combination of deep learning neural network, gradient boosted machines, and random forests, according to some aspects of the disclosure.

FIG. 4 illustrates an exemplary flow diagram showing a process for training transcription models using topic modeling, according to some aspects of the disclosure.

FIG. 5 illustrates an exemplary flow chart for pre-processing data, according to some aspects of the disclosure.

FIG. 6 illustrates an exemplary system diagram for optimizing the selection of transcription engines using a combination of selected preprocessors, according to some aspects of the disclosure.

FIG. 7 illustrates an exemplary overall system or apparatus for implementing processes of the disclosure, according to some aspects of the disclosure.

### DETAILED DESCRIPTION

The below described figures illustrate the described invention and method of use in at least one of its preferred, best mode embodiment, which is further defined in detail in the following description. Those having ordinary skill in the art may be able to make alterations and modifications to what is described herein without departing from its spirit and scope. While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

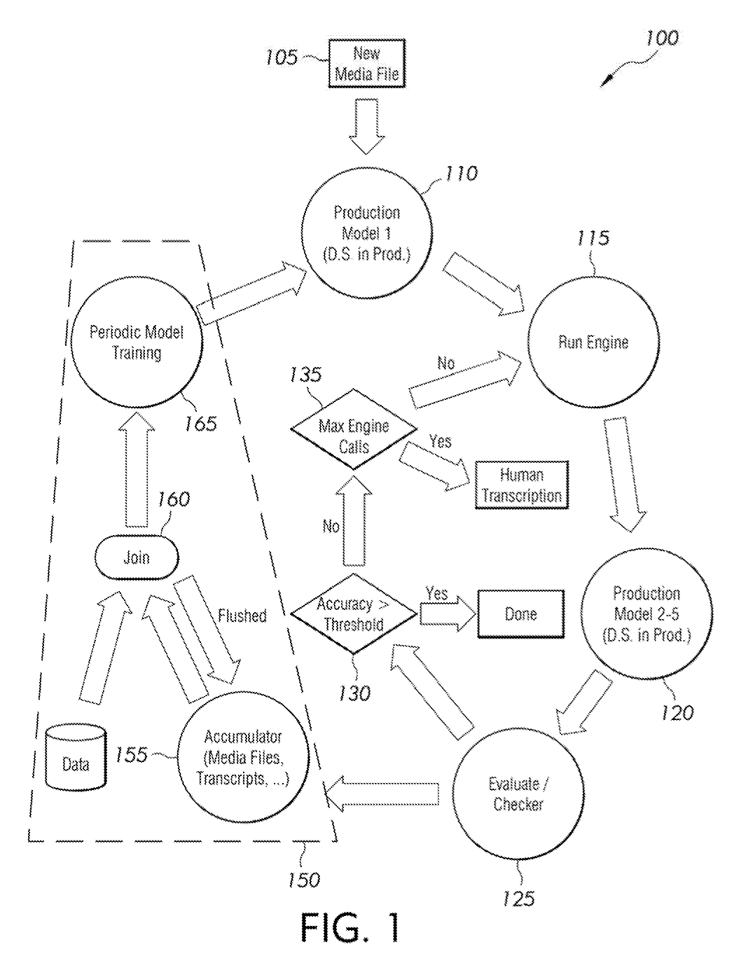

FIGS. 1 to 7 illustrate exemplary embodiments of systems and methods for creating and optimizing the selection of transcription engines to transcribe media files, using a combination of preprocessors and machine learning models, generating one or more optimal transcripts. Media files as used herein may include audio data, image data, video data, external data such as keywords, along with metadata (e.g., knowledge from previous media files, previous transcripts, etc.), or a combination thereof. Transcripts may generally include transcribed texts of the audio portion of the media files. Transcripts may be generated and stored in segments having start times, end times, duration, text specific metadata, etc. A system of the disclosure generally may include one or more network-connected servers, each including one or more processors and non-transitory computer readable memory storing instructions that when executed cause the processors to: use multiple preprocessors (data processing modules) to process media files for feature identification and extraction, and to create a feature profile for the media files; to create transcription models based on created feature profile; and to generate, with the use of one or more machine learning algorithms, a list of ranked transcription engines. One or more transcription engines may then be selected during a production run—a process where real clients' data are processed and transcribed. In some operations, the top-ranked engine may be selected. Each time a new media file is received for transcribing, it may also be used for further training of existing transcription models in the system.

The systems and methods for creating and optimizing the selection of transcription engines may be performed in real-time, or offline. In some embodiments, the system may run offline in training mode for an extended period of time, and run in real-time when receiving customer data (production mode).

### Overview

FIG. 1 is a high-level flow diagram depicting a process 100 for training transcription models, and optimizing production models in accordance with some embodiments of the disclosure.

Process 100 may start at 105 where a new media file to be transcribed may be received. As described later at 150, each time a new media file is received for transcribing, it may also be used for training existing transcription models in the system. The new media file (input file) may be a multimedia file containing audio data, image data, video data, external data such as keywords, along with metadata (e.g., knowledge from previous media files, previous transcripts, etc.), or a combination thereof. Once the input file is received, it goes through several preprocessors to condition, normalize, standardize, winsorize, and/or to extract features in the content (data) of the input file prior to being used as inputs of a transcription model. In some embodiments, features may be deleted, amended, added, or a combination thereof to the feature profile of the media file. For example, brackets can be deleted from a trascription. In another example, alphanumeric variables of one or more features (e.g., file type and encoding algorithm) can be converted into numeric variables for further processing (e.g., categorization and standardization). Feature identification and ranking may be done using statistical tools such as a histograms. Audio features may include pitch (frequency), rhythm, noise ratios, length of sounds, intensity, relative power, silence, and many others. Features may also include relationships between words, sentiment, recognized speech, accent, topics (e.g., sports, documentary, romance, sci-fi, politics, legal, etc.), and audio analysis variables such as mel-frequency cepstral coefficients (MFCC). Image features may include structures such as points, edges, shapes defined in terms of curves or boundaries between different image regions, or to properties of such a region, etc. Video features may include color (RGB pixel values), intensity, edge detection value, corner detection value, linear edge detection value, ridge detection value, valley detection value, etc.

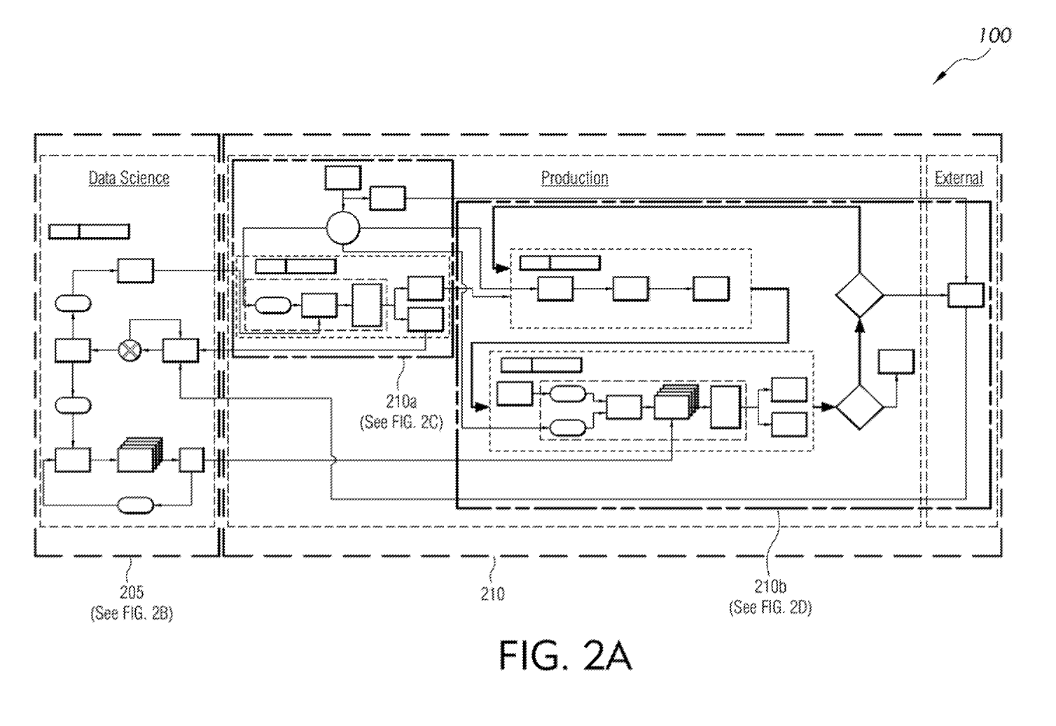

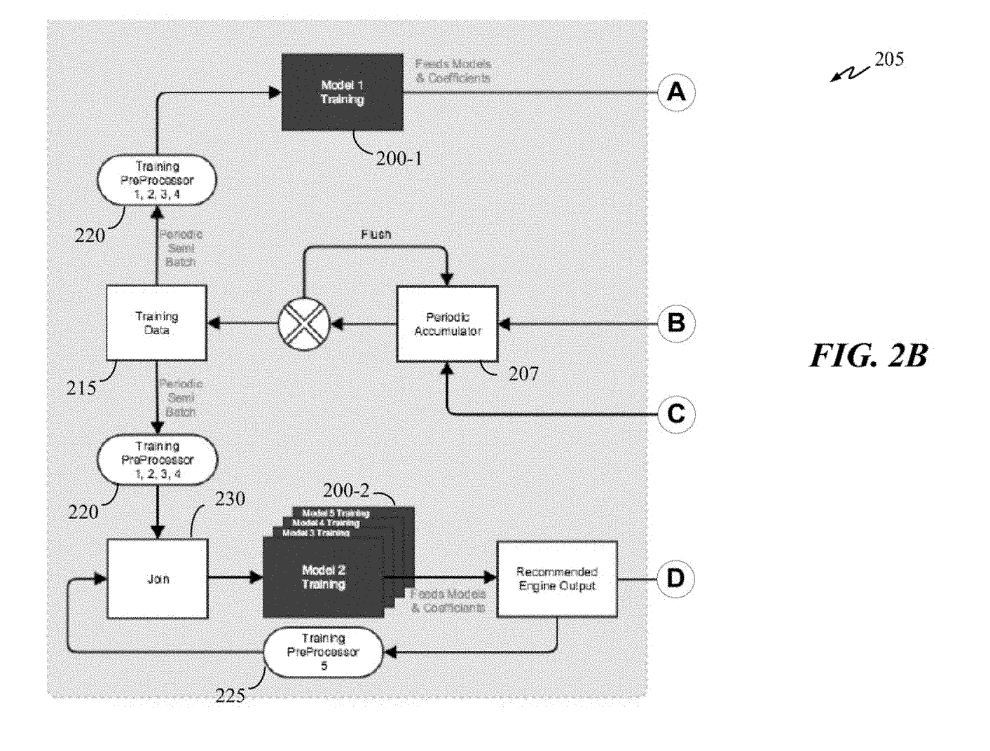

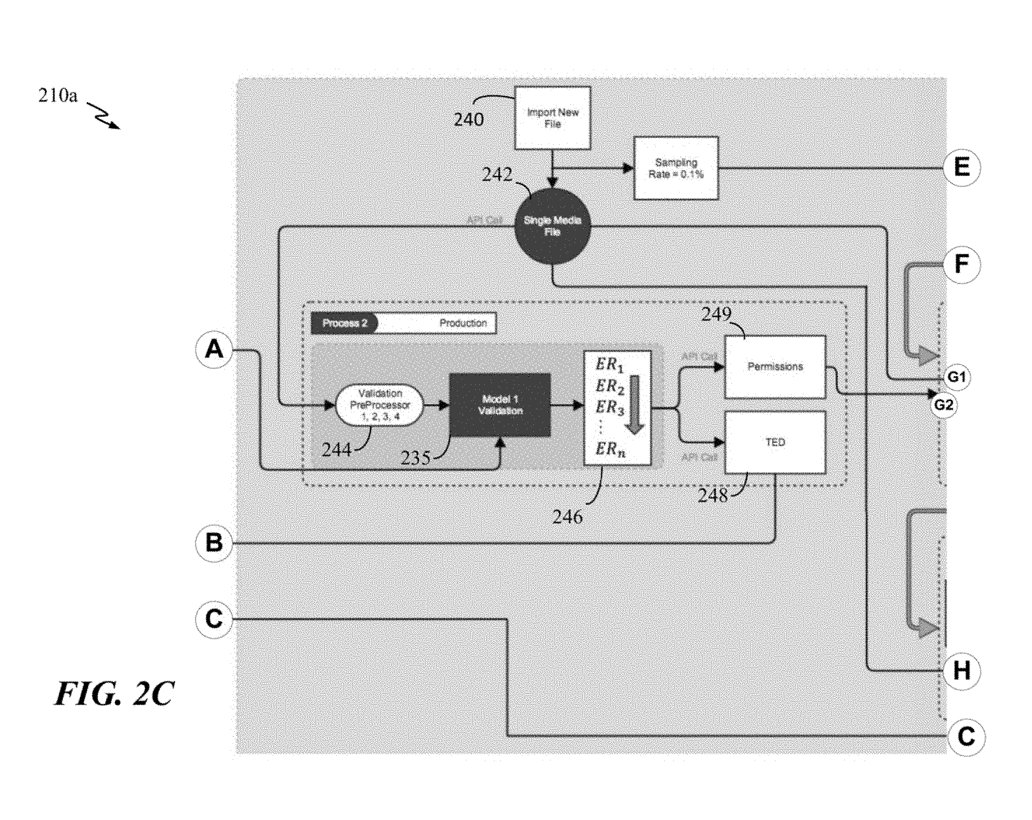

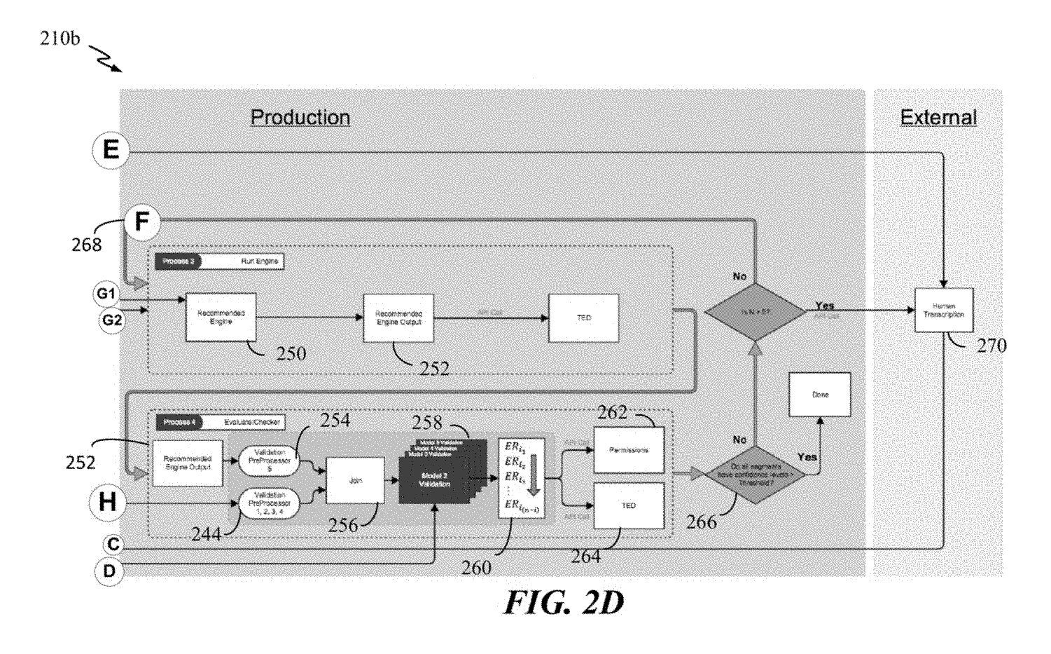

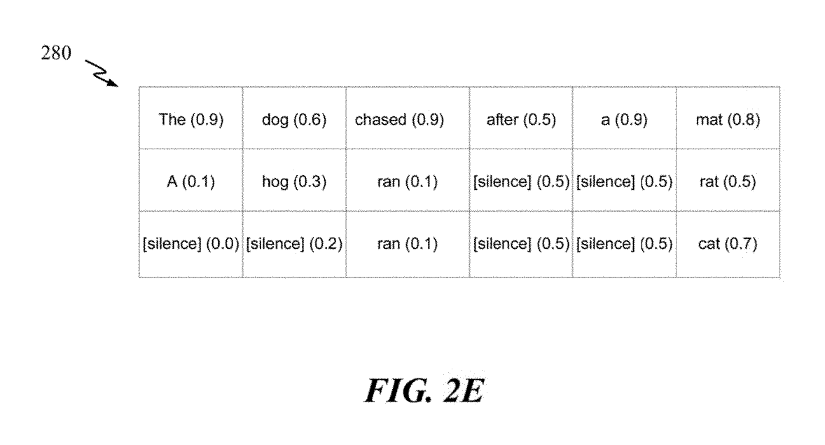

In some embodiments, seven preprocessors may be used to condition the content of the media file. They may include: alphanumeric, audio analysis, continuous variable (or continuous), categorical, or topic detection/identification. The outputs of each preprocessor may be joined to form a single cohesive feature profile from the input media file. In some embodiments, during a first transcription cycle, only four preprocessors are used to condition the content of the input media file. The four preprocessors used in the first transcription cycle may include an alphanumeric, an audio analysis, a continuous variable preprocessor, and a categorical preprocessor. The selection, combination and execution order of these four preprocessors may be unique and provide advantages not previously seen. In some embodiments, some of the selected preprocessors may run substantially in parallel, or in any other sequence, for example, based on one or more dependencies between the preprocessors, or any predetermined order. These advantages may include more flexibility, better efficiency, better performances, better prediction accuracy, and other advantages that will become obvious as described below. In some embodiments, the alphanumeric preprocessor may convert certain alphanumeric values to real and integer values. The audio analysis preprocessor may generate mel-frequency cepstral coefficients (MFCC) using the input media file and functions of the MFCC including mean, min, max, median, first and second derivatives, standard deviation and variance. The continuous variable preprocessor can winsorize and standardize one or more continuous variables. As known in the art, winsorizing or winsorization is the transformation of data by limiting extreme values in the statistical data to reduce the effect of possibly spurious outlier values. The categorical preprocessor can generate frequency paretos (histogram frequency distribution) of features in the feature profile generated by the alphanumeric preprocessor. The frequency paretos may be categorized by word frequency, in this way the most important features may be identified, and/or prioritized. In some embodiments, these preprocessors may be referred to as validation preprocessors (see also FIGS. 2C-D).

At 110, a selected transcription model may be used to transcribe the input media file. The transcription model may be one that has been previously trained. The transcription model may include executing one or more preprocessors, and using outputs of the preprocessors (which can take the form of a joined feature profile of the new media file). The transcription model may also use numerous training data sets (e.g., thousands or millions). Using the joined feature profile and/or training data sets, the transcription model may then use one or more machine learning algorithms to generate a list of one or more transcription engines (candidate engines) with the highest predicted accuracy. The machine learning algorithms may include, but not limited to: a deep learning neural network algorithm; a gradient boosted machine algorithm, and a random forest algorithm. In some embodiments, all three of the mentioned machine learning algorithms may be used to create a multi-model output, through “model stacking”.

As indicated, the transcription model may generate a list of one or more candidate transcription engines with the highest predicted accuracy that may be used to transcribe the content of the input media file received at 105. At 115, an initial transcription engine may be selected from the plurality of candidate engines to use in the initial round of transcription of the media file. The selection of the initial transcription engine may advantageously provide efficient input data for the subsequent procedures. In some embodiments, the transcription engine can be selected based on the highest predicted accuracy and the level of permission of the client. A permission level may be based on, for example, the price point or subscription level of the client. For example, a low price point subscription level can have access to a limited number of transcription engines while a high price point subscription level may have access to more or all available transcription engines.

At 120, the output of the selected transcription engine may be further analyzed by one or more natural language preprocessors now that the initial transcription for the media file is available. In some embodiments, a natural language preprocessor may be used to extract relationships between words, identify and analyze sentiment, recognize speech, and categorize topics. Each one of the extracted relationships, identified sentiments, recognized speech, and/or categorized topics may be added as a feature of a feature profile of the media file.

Similar to the preprocessing steps performed at 110, the content of the input media file may be preprocessed by a plurality of preprocessors such as, but not limited to, an alphanumeric, a categorical, a continuous variable, and an audio analysis preprocessor. In some embodiments, these preprocessors may run in parallel with the natural language processing (NLP), which is done by the NLP preprocessor. Alternatively, results generated by the plurality of preprocessors (not including the NLP preprocessor) at 110 may be reused. In some embodiments, the results and/or features from the plurality of preprocessors and the NLP preprocessor may be joined to form a joined feature profile, which is used as inputs for subsequent transcription models.

In this stage, the preprocessors may include an alphanumeric variable, a categorical variable, a continuous variable, an audio analysis, and a low confidence detection preprocessor. Results from each of the preprocessors, including results from the natural language preprocessor, may then be joined to create a single feature profile for the transcription output of the initial round.

At 125, at least another round of modeling may be performed. In this stage, the output of the selected transcription engine (transcription produced in the first round) may be evaluated by using the joined-feature profile (created at 120) as an input to one or more transcription models during the next (subsequent) round of modeling.

In some embodiments, the transcription model used at 125 may be the same transcription model at 110. Alternatively, a different transcription model may be used. Further, at 125, the transcription model may generate a list of one or more candidate transcription engines. Each candidate engine has a predicted accuracy for providing accurate transcription of the input media file. As more rounds of modeling are performed, the list of candidate transcription engines may be improved.

In some embodiments, the transcription engine with the highest predicted accuracy and proper permission may be selected to transcribe one or more portions or segments of the input media file. The outputs (transcription of the input media file) from the selected transcription engine may then be analyzed in one or more segments to determine confidence or accuracy value. At 130, if any segment has a low confidence value or an accuracy value below a given accuracy threshold, then another transcription engine may be selected from the list of candidate transcription engines to re-transcribe the segment or to re-transcribe the entire input media file. At this stage, the input media file will have undergone another stage of transcription, which will be more accurate than the previous stage of transcription because the transcript generated during the previous stage is used as input to the subsequent transcription stage, which may include the use of a natural language preprocessor in each subsequent transcription stage. As will be shown herein, processes 115, 120 and 125 may be repeated, thus the transcription will ultimately be even more accurate each time it goes through another cycle.

Looking ahead to 135, a check may be done to determine whether the maximum allowable number of engines has been called or maximum transcription cycles have been performed. In some embodiments, the maximum allowable number of transcription engines that may be called is five, not including the initial transcription engine called in the initial transcription stage. Other maximum allowable number of transcription engines may also be considered. Once the maximum allowable number of transcription engines called is reached, a human transcription service may be used where necessary. Back at 130, if the confidence or accuracy value is above a certain threshold, then the transcription process is completed.

Process 100 may also include a training process portion 150. As indicated earlier, each time a media file is received for transcribing, it may also be used for training existing transcription models in the system. At 155, one or more segments of the input media along with the corresponding transcriptions may be forwarded to an accumulator, which may be a database that stores recent input files and their corresponding transcriptions. The content of the accumulator may be joined with training data sets at 160 (described further below), which may then be used to further train one or more transcription models at 165. Thus, process 100 may continue to use real data for repeated training to improve its models.

### Architecture

Turning now to FIGS. 2A-E which illustrate exemplary flow diagrams showing further details of process 100 for optimizing the selection of transcription engines in accordance with some embodiments of the present disclosure. As described herein, each time a new media file is received for transcribing, it may also be used for further training of existing transcription models in the system. As such, FIG. 2A illustrates a high-level block diagram showing training process 205 and production process 210. FIGS. 2B-E show in further detail the processes and elements of FIG. 2A. In these embodiments, process 100 may include a training process 205 (shown in more detail in FIG. 2B) and a production process 210 (shown in more detail in FIGS. 2C-D).

FIG. 2B illustrates an exemplary detailed process flow of training process 205 which may be similar to process 150 of FIG. 1 above. In some embodiments, process 205 may include a training module 200, an accumulator 207, a training database 215, preprocessor modules 220, and preprocessor module 225. A module may include one or more software program or may be part of a software program. In some embodiments, a module may include a hardware component. Preprocessor modules 220 may include an alphanumeric preprocessor, an audio analysis preprocessor, a continuous variable preprocessor, and a categorical preprocessor (shown as training preprocessors 1, 4, 2, 3). The database 215 may include media data sets which may include, for example, customers' ingested data, ground truth data, and training data. In some embodiments, the database 215 may be a so called “temporal elastic database” (TED), where timestamps are also kept. A TED may improve performance when confidence values (which are time based, e.g., timestamps used) are calculated. In some embodiments, the database 215 may be distributed. Training module 200 may train one or more transcription models to optimize the selection of engines using a plurality of training data sets from training database 215. Training module 200, shown with training modules 200-1 and 200-2, may train a transcription model using multiple, e.g., thousands or millions, of training data sets. Each data set may include data from one or more media files and their corresponding feature profiles and transcripts. Each data set may be a segment of or an entire portion of a large media file.

A feature profile can be outputs of one or more preprocessors such as, but not limited to, an alphanumeric, an audio analysis, a categorical, a continuous variable, a low confidence detection, a natural language processing (NLP) or topic modeling preprocessors. Each preprocessor generates an output that includes a set of features in response to an input, which can be one or more segments of the media file or the entire media file. The output from each preprocessor may be joined to form a single cohesive feature profile for the media file (or one or more segments of the media file). The joining operation can be done at 220 or 230 as shown in FIG. 2B.

Prior to training a transcription model using training modules 200, data of a training data set may be pre-processed in order to condition, normalize, standardize, and winsorize the input data. Each preprocessor may generate a feature profile of the input data. As described herein, a feature may include, among others, a deletion, a substitution, an addition, or a combination thereof to one of the metadata or data of the media file. For example, brackets in the metadata or the transcription data of the media file can be deleted. A feature can also include relationships between words, sentiment, recognize speech, accent, topics (e.g., sports, documentary, romance, sci-fi, politics, legal, etc.), and audio analysis variables such as mel-frequency cepstral coefficients (MFCC). The number of MFCCs generated may vary. In some embodiments, the number of MFCCs generated may be, for example, between 10 and 20.

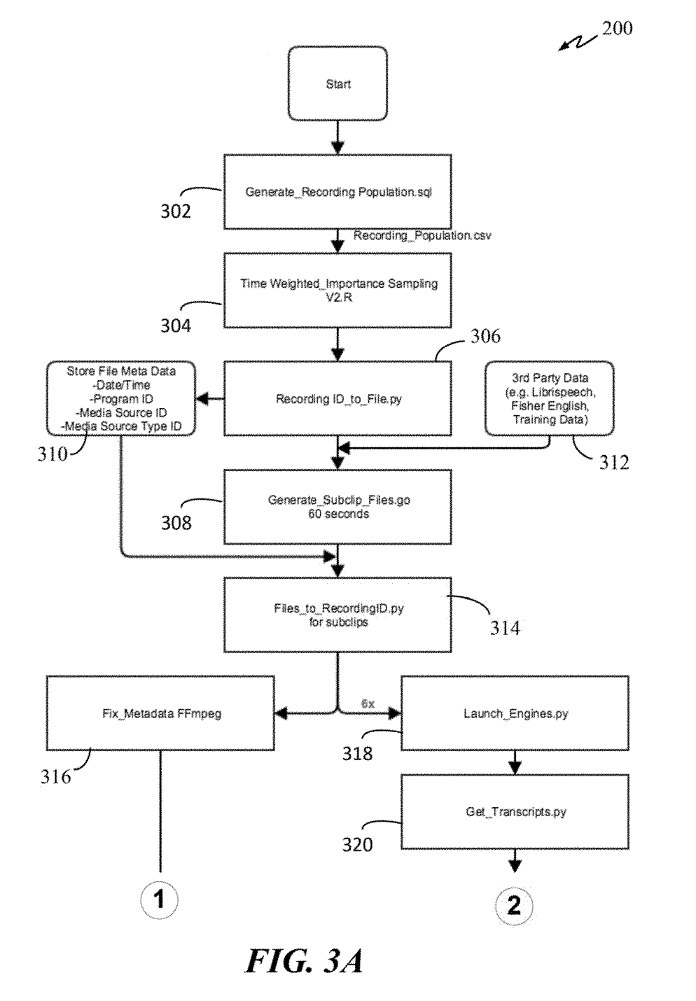

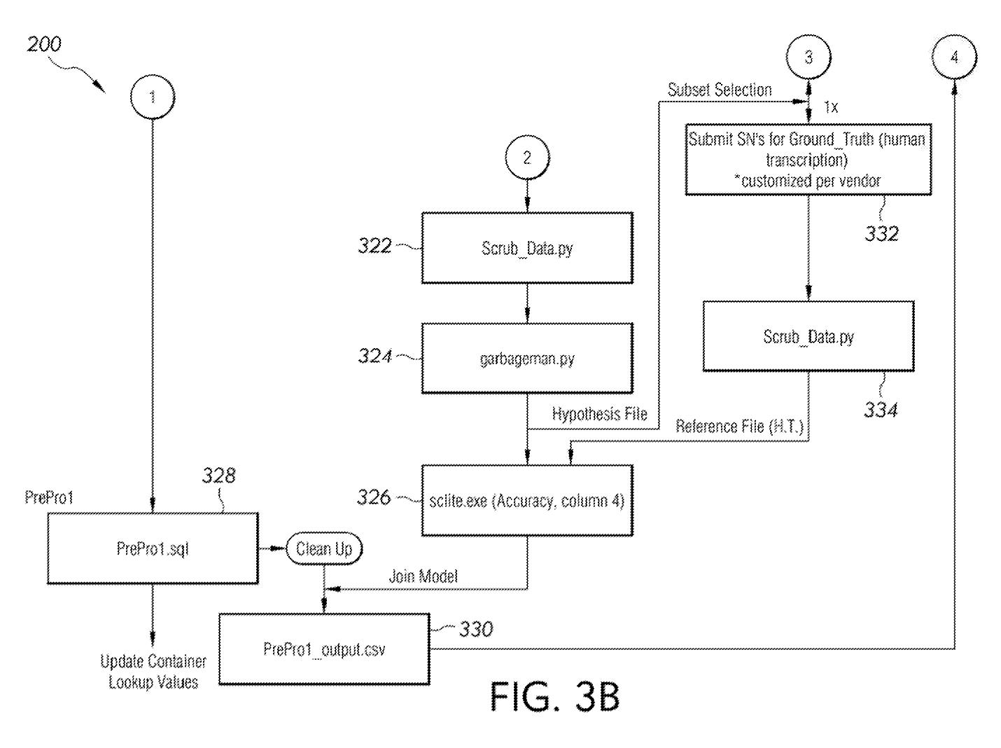

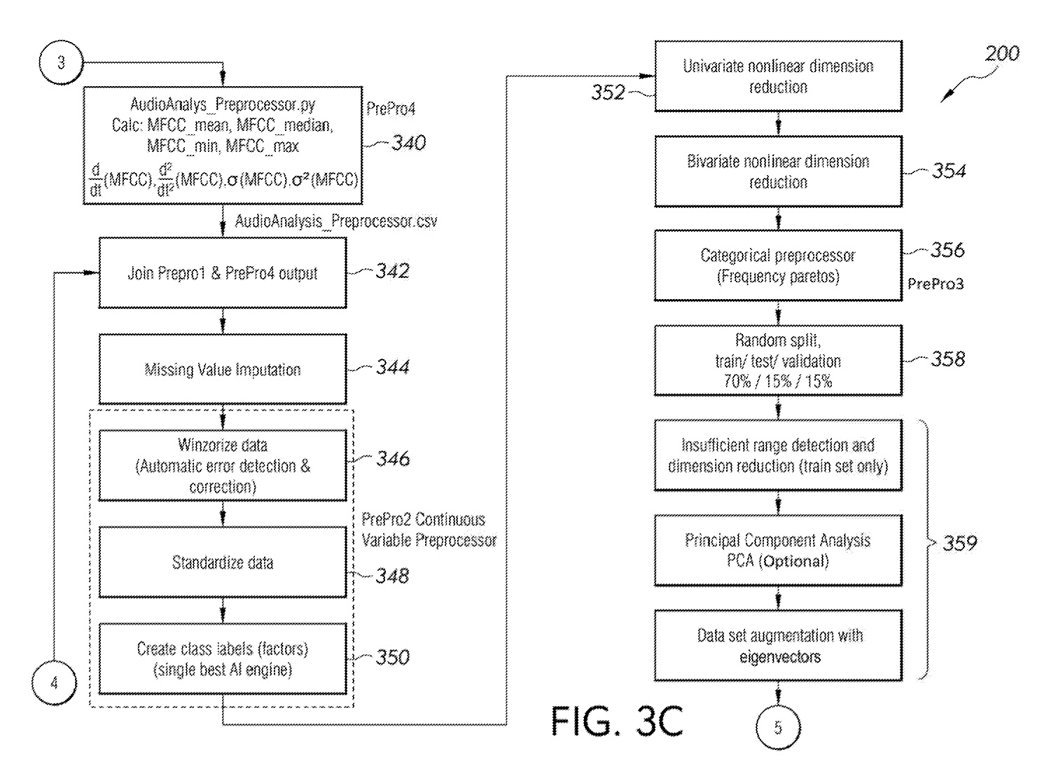

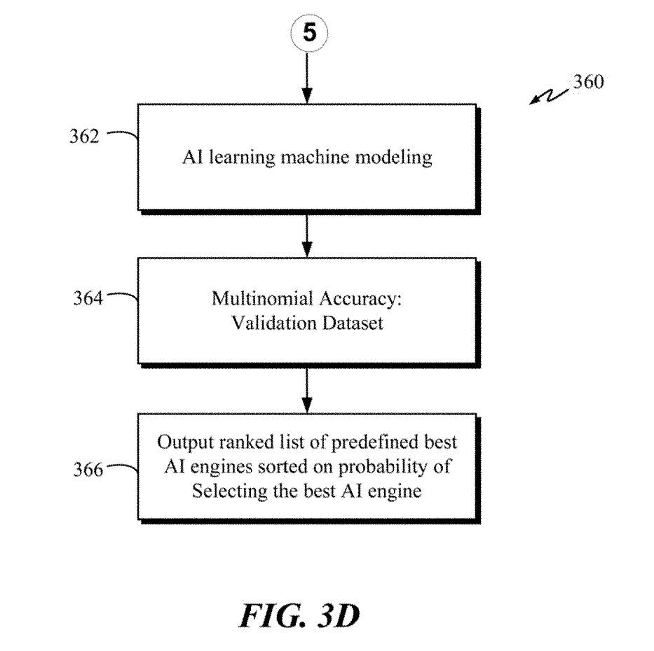

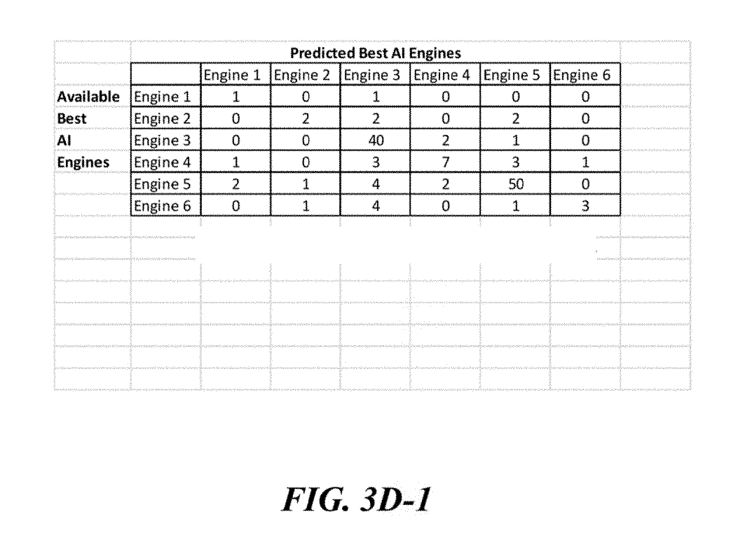

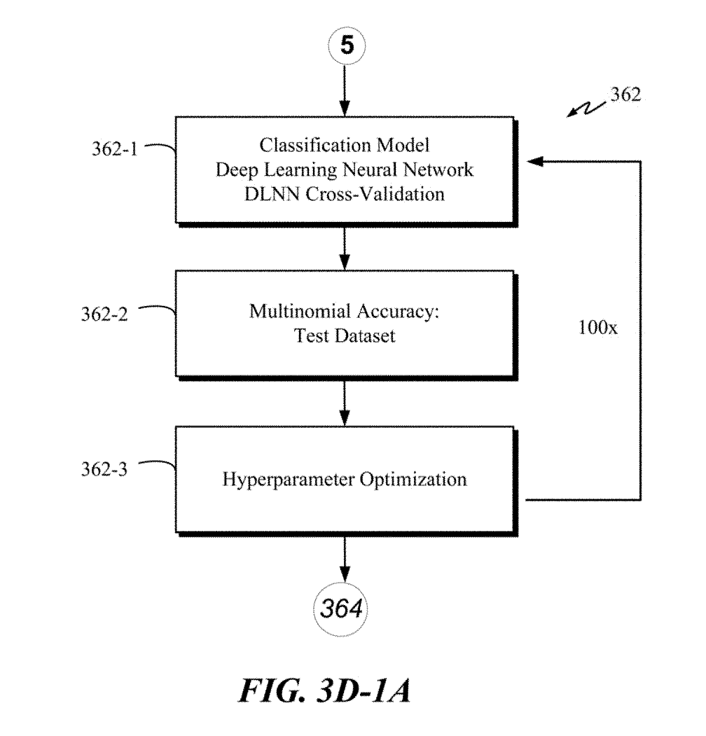

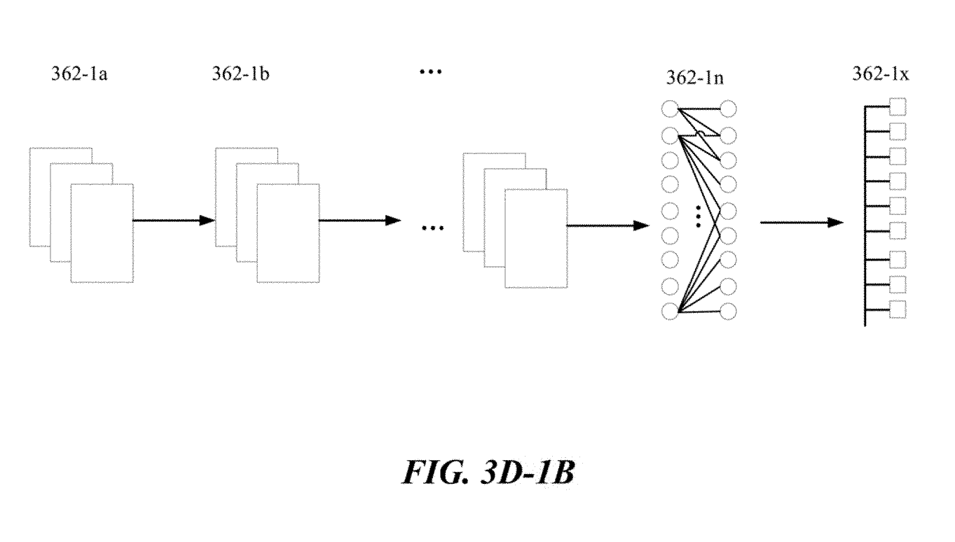

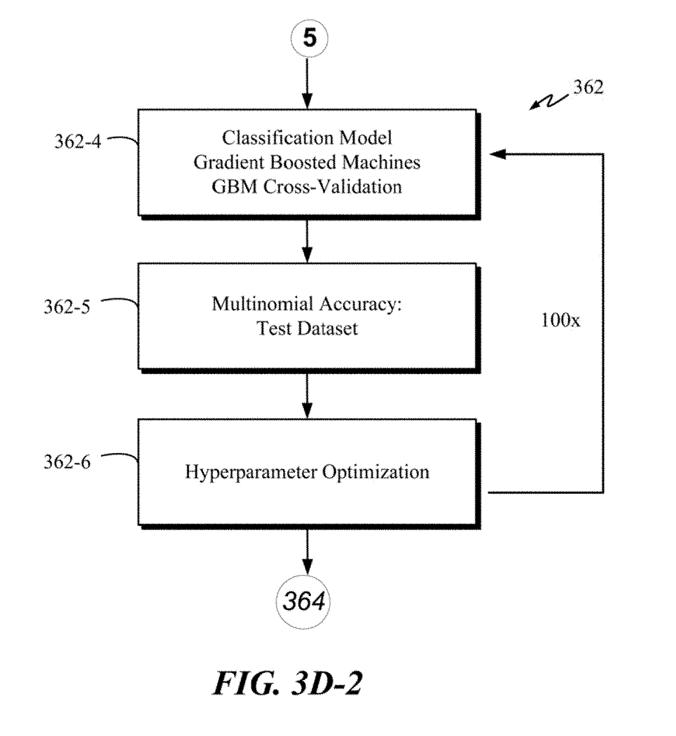

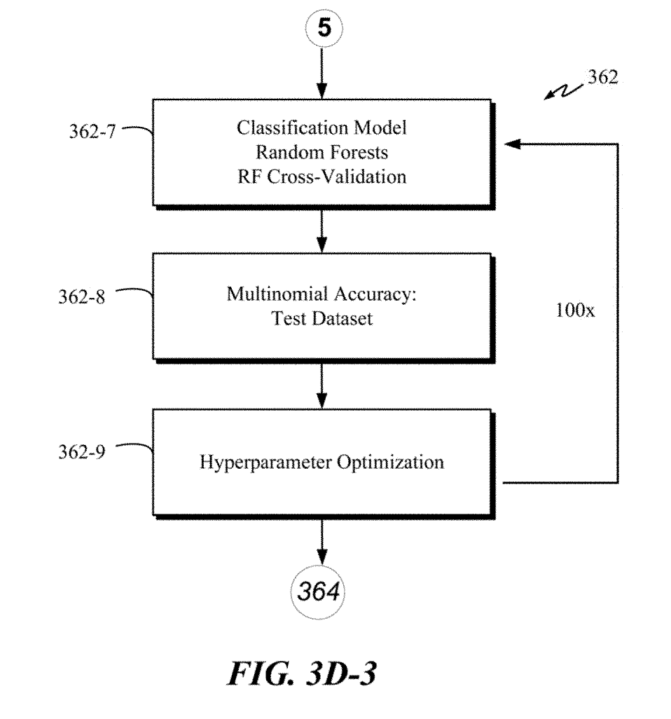

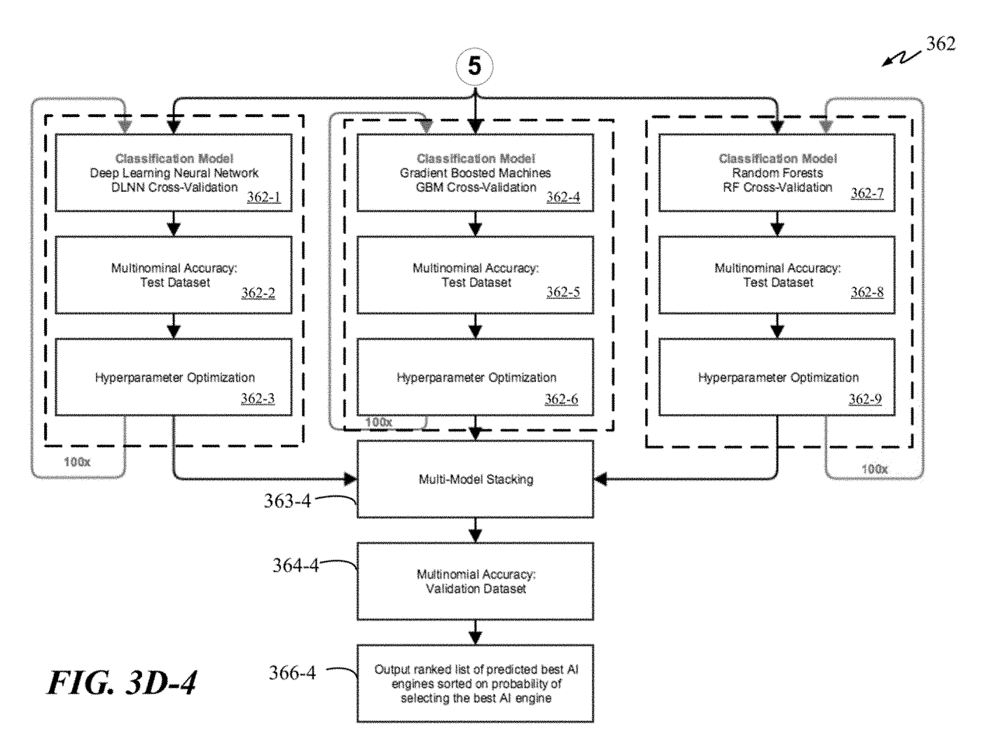

In some embodiments, training module 200-1 may train a transcription model using training data sets from existing media files and their corresponding transcription data (where available). This training data is illustrated in FIG. 2B as coming from the database (TED) 215. As noted herein, the database 215 may be periodically updated with data from recently run models via an accumulator 207. In some embodiments, if a training data set does not have a corresponding transcript, then a human transcription may be obtained to serve as the ground truth. As an example, the human ground truth is illustrated in FIG. 2B as coming from label C, which is from the human transcription 270 shown in FIG. 2D. As used herein, ground truth may refer to the accuracy of the training data set's classification. In some embodiments, training module 200-1 only trains a transcription model using only previously generated training data set, which is independent and different from the input media file. In contrast, in some embodiments, modeling module 200-2 may train one or more transcription models using both existing media files and the most recent data (transcribed data) available for the input media file. In some embodiments, the training modules 200-1 and 200-2 may include machine learning algorithms. A more detailed discussion of training model 200 is provided below with respect to FIGS. 3A-3D.

In some embodiments, input to the training module 200-3 may include outputs from a plurality of training preprocessors 220, which are combined (joined) with output from training preprocessor 225. Preprocessors 220 may include an alphanumeric preprocessor, an audio analysis preprocessor, a categorical preprocessor, and a continuous variable preprocessor. Preprocessor 225 may include one or more preprocessors such as, but not limited to, a natural language preprocessor to determine one or more topic categories; a probability determination preprocessor to determine the predicted accuracy for each segment; and a one-hot encoding preprocessor to determine likely topic of one or more segments. Each segment may be a word or a collection of words (i.e., a sentence or a paragraph, or a fragment of a sentence).

As noted above, accumulator 207 may collect data from recently run models and store it until a sufficient amount of data is collected. Once a sufficient amount of data is stored, it can be ingested into database 215 and used for training of future transcription models. In some embodiments, data from the accumulator 207 is combined with existing training data in database 215 at a determined periodic time, for example, once a week. This may be referred to as a flush procedure, where data from the accumulator 207 is flushed into database 215. Once flushed, all data in the accumulator 207 may be cleared to start anew.

FIG. 2C is an exemplary flow diagram illustrating in further detail portion 210a of the transcription engine selection optimization process 100. Portion 210a is part of the production process where preprocessors 244 and a trained transcription model 235 may be used to generate a list of candidate transcription engines 246 (shown as “ER”, Engine Rank) using real customers' media files as the input. At 240 and 242, a new media file is imported for transcription. The new media file may be a single file having audio data, image data, video data, or a combination thereof.

As shown, the input media file may be received and processed by one or more preprocessors 244, which may be similar to training preprocessors 220. Preprocessors 244 may include an alphanumeric preprocessor, an audio analysis preprocessor, a categorical preprocessor, and a continuous variable preprocessor (shown as preprocessors 1, 2, 3, 4). One of the major differences between training preprocessors 220 and preprocessors 244 is that the features and coefficients outputs of the training preprocessors 220 are obtained using thousands or millions of training data sets. Whereas, the features of preprocessors 244 are obtained using a single input (data set), which is the imported media file 240 along with certain values obtained and stored during training such as medians of variables, used in missing value imputation, and values obtained during the winsorization calculations, standardization calculations, and pareto frequency calculations. In some exemplary operations, values obtained during training are stored in two-dimensional arrays. During production run, these values are ingested into a software container as a one-dimensional array. This advantageously improves performance speed during the production runs.

In some embodiments, preprocessors 244 may output a feature profile that may be used as the input for transcription model 235. The feature profile may include results from alphanumeric preprocessing, MFCCs, results from winsorization of continuous variables (to reduce failure modes), and frequency paretos of features in the feature profile of the input media file. In response to the feature profile input from preprocessors 244, transcription model module 235 may generate a list 246 of best candidate engines to perform the transcription of the input media file 240. In some embodiments, transcription model module 235 may use one or more machine learning algorithms to generate a list of ranked engines based on the feature profile of the input file and/or training data sets. In some embodiments, if the top ranked engine has the proper permission 249, then an API call may be made to request that transcription engine to transcribe the input media file 240. The output of transcription model module 235 may also be stored in a database 248, which can forward the collected data to accumulator 207 which accumulates data for future training. Similar to the database 215 described herein, the database 248 may include media data sets which may include, for example, customers' ingested data, ground truth data, and training data.

In some embodiments, parts of a preprocessor may be used for different input data (e.g., audio, image, text, etc.).

FIG. 2D is an exemplary flow diagram illustrating portion 210b of the transcription engine selection optimization process 100. Similar to portion 210a, portion 210b is part and continuation of the production process where one or more trained transcription models (as shown with label D) may be used to generate a list of candidate transcription engines using real customer data as the input (as shown with labels H and G1). First (as shown in Process 3), a recommended transcription engine 250 may be selected from the list of best candidate engines (shown with label G2, as recommended engine selected after permissions 249). In some embodiments, the engine 250 may also be selected based on the type of the media file, for example, a WAVE audio file, an MP3 audio file, an MP4 audio file, etc. The engine 250 may be recommended based on previous learning by the machine learning algorithms described herein.

Engine 250 may generate an output 252, which may be a transcript and an array of confidence values. Turning briefly to FIG. 2E which illustrates an exemplary transcript segment of output 252. In some embodiments, the output 252 may advantageously include a transcript and a special multi-dimensional array 280 of transcribed words (or silent periods), wherein each transcribed word (or silent period) may be associated with a confidence score. In the FIG. 2E example, an input audio segment may have one transcript as “The dog chased after a mat.” Each word is associated with a confidence score, for example, “The” has a confidence score of 0.9, “dog” has a confidence score of 0.6, and so on. The same input may have another transcript, for example, from another selected engine, as “A hog ran [silence] rat,” with each word or silent period having an associated confidence score. In some embodiments, the words (or silence) may be ranked based on the confidence scores. Other data included, but not shown, in each element of the multi-dimensional array 280 may include, for example, start and end times of the word in the transcript, time duration (e.g., in milliseconds) of the word, information on forward and backward paths or links, and so on. The special multi-dimensional array of transcribed words with confidence ranking may provide information regarding how a model performs, provide better efficiency and performance in training future transcription models and engines, and better transcription engines. In some embodiments, a search engine may be able to perform search on one or more elements of the array. Returning to FIG. 2D, output 252 may then be stored in a database (TED) for use in the training of future transcription models.

An evaluation and check process (as shown in Process 4) may be run next. Output 252 may also be used as the input for preprocessor 254. In some embodiments, preprocessor 254 may be a natural language preprocessor that can analyze the output transcription to extract relationship between segments or words, analyze sentiment, and categorize topics, etc. Each one of the extracted relationships, identified sentiments, recognized speech, and/or categorized topics may be added as a feature of a feature profile of the media file.

Additionally, preprocessor 254 may also include a probability determination preprocessor to determine the predicted accuracy for each segment; and a one-hot encoding preprocessor to determine likely topic of one or more segments. Each segment can be a word or a collection of words (e.g., a sentence or a paragraph).

The evaluation and check process may also receive the media file 240 (see label H) and run it through one or more preprocessors 244. In some embodiments, the preprocessors 244 may include an alphanumeric preprocessor, an audio analysis preprocessor, a categorical preprocessor, and a continuous variable preprocessor (shown as preprocessors 1, 2, 3, 4).

Prior to performing another cycle of transcription using transcription engine model 258, which may be the same as transcription model 235 in FIG. 2C, the outputs of preprocessors 244 and 254 may be joined at 256. The main difference between transcription models 235 and 258 is that the latter can use actual transcription data, generated by the selected transcription engine at 250, for the input media file 240 to further improve the transcription accuracy.

At 260, transcription model 258, which may be a regression analysis model, generates a list 260 of best candidate engines (e.g., ranked by engine ranks, or ER's) that may be used to transcribe one or more segments of input media file 240 based on the multi-dimensional confidence array from output 252. At 262, the candidate engine with the highest rank and with the proper permission may be selected to transcribe one or more segments of the input media file 240. The output of the candidate engine may be a transcript of the media file and an array of confidence factors for one or more segments of the media file.

The list of the ranked engines at 260 may also be stored in database 264 (TED). Similar to the database 215 and 248 described herein, the database 264 may include media data sets which may include, for example, customers' ingested data, ground truth data, and training data. At 266, a check may be performed to see if all segments of the input media file have been transcribed with a certain level of confidence. If the confidence level (e.g., predicted accuracy) meets or exceeds a certain threshold, then the transcription process may be completed. If the confidence level does not meet the threshold, then another transcription cycle may be performed by looping back to 268 where another engine may be selected from the list of candidate engines (generated at 260). The transcription loop can be repeated many times until substantially all segments are transcribed at a desired level of confidence, usually a predetermined high level of confidence. In some embodiments, the maximum number of transcription loops may be set, for example, at five as shown. If the confidence level is still low for one or more segments after the maximum transcription loops have been performed, then a human transcription may be requested at 270. In some embodiments, the threshold may be associated with certain cost constraints, for example, the threshold may depend on a fee the customer pays.

### Data Preprocessing and Modeling

Turning now to FIGS. 3A-D which illustrate exemplary flow diagrams showing further details of process 200 (200-1 and 200-2 in FIG. 2B) for training a transcription model to optimize the selection of one or more transcription engines in accordance with some embodiments of the present disclosure. In some embodiments, training process 200 may start at 302 where a recording population of one or more training data sets (or data) is generated. The training data may include hundreds, thousands, or even millions of media files. As described above in FIGS. 2A-D, each media file in this stage may include a corresponding transcription, and if a transcript is not available, a human transcription may be requested.

At 304, the training data (media files) may be time weighted. In some embodiments, random sampling of the training data may be time weighted based on the time of the data received. For example, recent training data may be weighted more heavily than old training data, as they may be more relevant, etc. At 306, recording IDs may be created/selected for the media files. At 310, metadata data for each of the file is stored. The metadata stored may include, but not limited to, date and time created, program identifier, media source identifier, and media source type, bitrate, sample rate, channel layout, and so on. The metadata may later be included in a transcript to identify the data source. At 312, third party training data sets may also be ingested and used for the training of the transcription model. Examples of third party training data may include Librispeech, Fisher English Training Data, and the like. At 308, each file may be optionally split into sub-clips/chunks, for example with 60-second duration. At 314, each sub-clip (which may be treated as files) generated may be assigned an ID. After 314, the system may take two parallel paths which will merge back later.

At the first parallel path 316, the metadata may be optionally fixed or corrected for any potential errors, for example in an FFmpeg file.

At the second parallel path 318, a group of one or more pre-selected transcription engines to be trained may be launched (hereinafter is referred to as transcription engine 318) to run on a time weighted importance subset of data. The transcription engines may generate transcriptions (or transcripts). In some exemplary embodiments, the group of pre-selected transcription engines has at least six transcription engines. In some embodiments, each of the six transcription engine 318 may be launched separately using the training data received and processed at processes 302 through 314 as inputs.

At 320, the transcript from each transcription engine is received (hereinafter is referred to as transcript 320). In some embodiments, a multi-dimensional array of confidence values for a plurality of segments of each training data set may also be generated by the transcription engine.

Referring to now FIG. 3B, at 322, transcript 320 can be cleaned (or scrubbed) where data such as speakers ID, brackets, and accents information may be optionally removed. In some embodiments, process 322 may be part of natural language processing normalization. At 324 certain files may be removed. In some embodiments, the removed files may contain data that is not to be transcribed. For example, one or more music segments may be removed. The output of 324 may be referred to as hypothesis file.

Also at 324, after certain files may be removed, the process may also branch off to 332. At 332, in some embodiments, subsets of the cleaned data (may be identified with serial numbers) may be selected and submitted to obtain ground truth, by having a person listening to the data and transcribe it. The human generated transcript may be presumed to be substantially close to 100% accurate. At 334, the human generated transcription of 332 may be cleaned (or scrubbed). In some embodiments, the cleaning at 334 may be similar to the cleaning at 322, for example, where speaker ID, brackets, and accents info may be optionally removed. The human generated ground truth output of 334 may be referred to as a reference file.

Both the hypothesis file from 324 and reference file from 334 may then be input to 326. At 326, an accuracy score may be calculated, for example using a National Institute of Standards and Technology (NIST) sclite program, by comparing and aligning the reference file (human transcription) with the artificial intelligence (AI) engine (transcription engine) hypothesis transcription file.

As noted above, processes 318 through 326 may be run multiple times for multiple transcription engines to generate multiple accuracy scores. In some exemplary embodiments, these processes may be run six times for six transcription engines to generate six accuracy scores.

Back at the first parallel path 314-316, data may be input into an alphanumeric preprocessor 328.

At 328, the alphanumeric preprocessor may take the media file data including metadata from 314-316 as inputs and convert alphanumeric values into real and integer values. In some embodiments, this conversion may be needed as one or more other preprocessors and the machine learning algorithms described herein may only process numerical input values, not alphanumeric values.

In some embodiments, the output of 326 (which may include one or more accuracy scores) and the output of 328 (real and integer values from preprocessor 328) may then be joined.

Referring now to FIG. 3C, back at 324 in FIG. 3B, the hypothesis file may also be forwarded to another preprocessor 340, which may be an audio analysis preprocessor. In some embodiments, the audio analysis preprocessor 340 may analyze the data to generate Mel-frequency cepstral coefficients (MFCCs) from which vectors may be used to calculate statistics (e.g., mean, standard deviation, variance, min, max, median, first and second derivatives with respect to time, etc.), which may provide new dimensions for the data and generating more features. The number of MFCCs generated may vary, for example, between 10 and 20 in some embodiments. In some embodiments, the audio analysis preprocessing may include creating a Fast Fourier Transform and perform non-linear audio correction from actual power output to an MFC curve, then produce an Inverse Fast Fourier Transform to generate MFCCs. At 342, the outputs of audio analysis preprocessor 340 and alphanumeric preprocessor 328 may be joined, for example combining data sets to create a single feature profile of an input media clip.

At 344, any missing value in the joined feature profile may be replaced with a median or mean value, or a predicted value, which is generated by audio analysis preprocessor 340.

At 346, the output of process 344 may be winsorized to detect and correct for errors. In some embodiments, the winsorization process looks for outliers in a continuous variable and corrects the outliers. For example, the data may be sorted and compressed by eliminating the low-end and high-end 0.5% outliers. The outliers may be errors, for example, input by a human and which would distort the data values.

At 348, the data may be standardized to enable comparison between different features or the same features but from different output sources (e.g., alphanumeric preprocessor, audio preprocessor, different transcription engines that may use different scale of confidence (e.g., due to internal functions of engines, what is more important to each engine), etc.). In some embodiments, the mean may be subtracted out and divided by unit variance.

At 350, class labels may be created for the output. Class labels may also be known as factors. Process 350 may also be known as classification model. In some embodiments, processes 346 through 350 may be considered as part of a continuous variable preprocessor.

At 352, a univariate nonlinear dimension reduction may be performed on the output of the continuous variable preprocessor (or processes 346-350). In some embodiments, any variables that are not substantially correlated with a variable in the output may be eliminated. As a result of certain variables being eliminated, solution space problems may be reduced, and the produced model may be more predictive.

Next, at 354, a bivariate nonlinear dimension reduction may be performed. Here, two input variables may be compared and if they are highly correlated (for example, over 95%, such that not much information may be gained by having both), then one of the two variables may be eliminated in order to reduce the features set/profile. In some embodiments, 354 may be a nested loop.

At 356, a categorical preprocessor may be used to create frequency paretos (e.g., histogram frequency distribution) on each of the features. In some embodiments, features are categorized and only features in certain frequency are kept, and others are compressed together. For example, certain variables may appear in high frequency (e.g., in the tens of thousands times) causing a sparse data set.

It should be noted that although the categorical preprocessor 356 is shown to run after the continuous variable preprocessor (or processes 346-350), in some embodiments, the categorical preprocessor 356 may run before the continuous variable preprocessor.

At 358, the output of 356 may go through a random split in order to reduce bias and variance in the model. In some embodiments, a three-way random split may be used, splitting into train, test and validation, at, for example, 70%, 15% and 15% respectively.

At 359, the output or feature profile can further be processed as shown. First, insufficient range detection and dimension reduction may be performed on a training data set. It should be noted that principal component analysis (PCA), which is a method of dimension reduction, may be optionally performed. If PCA is performed, data augmentation may be performed on the eigenvectors from the PCA, joining the eigenvectors with other dimensions, thus increasing the feature set. The output of process 359 may then go to one or more machine learning algorithms to model the transcription.

FIG. 3D illustrates an exemplary modeling process 360 using one or more machine learning classification algorithms/models, also referred to herein as machine learning algorithms or models. The machine learning models generally provide the ability to automatically obtain deep insights, recognize unknown patterns, and create highly accurate predictive models from available data. In other words, the machine learning models may use their algorithms to learn from available data in order to build models that give accurate predictions or responses, or to find patterns, particularly when they receive new and unseen similar data. The machine learning algorithms train the models to translate the input data into a desired output value. In other words, they assign an inferred function to the data so that newer examples of data will give the same output for that “learned” interpretation. The machine assigns an inferred function to the data using extensive analysis and extrapolation of patterns from new and/or training data. In some embodiments, at 362, the machine learning algorithms/models used to model a transcription engine selection process may include a deep learning neural network model (DLNN model), a gradient boosted machine model (GBM model), and a random forests model (RF model). In some embodiments, the machine learning algorithms/models used to model a transcription engine selection process may advantageously combine DLNN model, GBM model, and RF model. The advantages for this combination and order of the three machine learning models may include, for example, optimized variance-bias tradeoff to improve accuracy on future unseen data, improved computer processing efficiency, improved computer processing performance, improved prediction, improved accuracy, and better transcription engines. The results from the machine learning modeling process (may be hundreds of models) may be combined in a multi-model stacking procedure or algorithm at 363.

At 364, a multinominal accuracy procedure may be performed on the test data set portion generated at 358 above, e.g., on the 15% test data set. This is to reduce bias and variance in the model. The system may determine some trade-off balance between bias and variance, as it tries to simultaneously minimize both the bias and variance. The bias is an error from erroneous assumptions in the learning algorithm. High bias can cause an algorithm to miss the relevant relations between features and target outputs (known as underfitting). The variance is an error from sensitivity to small fluctuations in the training set. High variance can cause an algorithm to model the random noise in the training data, rather than the intended outputs (known as overfitting). Process 364 may be a predicting process portion. In some embodiments, at 364, a “confusion matrix” may be set up and evaluated to calculate the percentage accuracies of the engines that have been run. The transcription engines may also be referred to as Artificial Intelligence (AI) engines. An example of a confusion matrix is illustrated in FIG. 3D-1. In this example, six engines are selected as the predicted best engines. During execution, their actual percentage accuracies are recorded as shown. For example, Engine 3 recorded a 40% accuracy. The 40% accuracy was recorded out of the total of 54% percentage for actual percentage accuracies for all six engines, while Engine 5 recorded a 50% accuracy. A percentage accuracy for all engines may be calculated as

Percentage of Accuracy=(Σ Diagonal Values/Total Value)×100

As such, the total percentage of accuracy in the example of FIG. 3D-1 is 76.87% ((103/134)×100), where the diagonal values are 1, 2, 40, 7, 50 and 3, and the Total Value is the sum of all values in the matrix.

At 366, modeling process 360 may provide a ranked list of candidate transcription engines based on the highest probability of accuracy. In the example of FIG. 3D-1, Engine 5 may be ranked highest (having 50% accuracy), then Engine 3 (having 40% accuracy), and so on. In some embodiments, engines may also be associated with permissions. In some exemplary implementations, a customer/user may have paid permission to use a group of engines only. If so, the highest ranked engine with the associated permission may be used for that customer.

FIGS. 3D-1A and 3D-1B illustrate an exemplary modeling process 362 using deep learning neural network (DLNN) to improve detection of patterns of features and to improve generation of classified categories. In some embodiments, at 363-1, the DLNN algorithms may include a plurality of layers for analyzing and learning the data in a hierarchical manner, for example, layers 362-1a, 362-1b . . . 362-1n. This is to extract, using the layers, features through learning. Some layers may include connected functions (e.g., layer 362-1n). Layers may be part of data processing layers in a neural network. Each layer may perform a different function. For example, a layer may detect patterns in a data, e.g., in an audio clip, on an image, etc. The next layer ingests outputs from the previous layer and so on. The DLNN algorithms of model 365 may include a plurality of layers to provide accurate pattern detection. The DLNN algorithms of model 365 learn and attribute weights to the connections between the different “neurons” each time the network processes data.

In some embodiments, the deep learning neural network algorithms of model 362-1 may include regressions which model the relationship between variables. By observing these relationships the model 362-1 may establish a function that more or less mimics this relationship. As a result, when the model 362-1 observes more variables, it can say with some confidence and with a margin of error, where they may lay along the function.

In some embodiments, the deep learning neural network algorithms of model 365 may include connections where each connection may be weighted by previous learning events and with each new input of data more learning takes place.

In some embodiments, the deep learning neural network algorithms of model 362-1 may classify the input data into categories. For example, the categories are classified at 362-1x.

In some embodiments, each machine learning model (e.g., DLNN model, GBM model, RF model, or a combination thereof) ingests the output features set/profile from process 358 and/or 359 as input and perform a ten-way cross validation. In other words, each training is split into 10 chunks, each chunk is validated against the 9 other chunks. For example, the process models 9 chunks and predicts the 10th, then rotates 10 times. Validation is performed for each chunk until all 10 chunks are validated, and the results are combined.

At 362-2, as the DLNN model may provide multi-class classification, a multinominal accuracy procedure may be performed on the test data set portion of process 358. This is to reduce bias and variance in the model. Step 362-2 may be a predicting step. The multinomial accuracy procedure calculates the percent correct predictions for all of the classes combined. Some embodiments of this step are also described in Step 364 above. At 362-3, hyperparameters of the data set may be adjusted to optimize the model. The hyperparameters may include external variables set before each training. These may include variables pertaining to each machine learning algorithm. For example, in a neural network the variable may be the number of layers, number of hidden neurons within each layer, type of activation function (hyperbolic tangent with or without dropout, sigmoidal with or without dropout, rectified linear with or without dropout), dropout percent, L2 regularization value to reduce overfitting. In some embodiments, processes 362-1 to 362-3 may be repeated, e.g., 100 times, creating 100 predictive DLNN models. The process then continues at 364, back at FIG. 3D.

FIG. 3D-2 illustrates an exemplary modeling process 362 using gradient boosted machines (GBM) to improve prediction of patterns of features and to improve generation of multiclass classified categories. In some embodiments, at 362-4, the GBM modeling may include iterative algorithms combining multiple models into a strong prediction model. At each iteration, a subsequent model may be improved over the previous model. The subsequent model may focus on any errors (e.g., misclassifications of words, etc.) that the previous model may make and learn to improve its own model. In some embodiments, the number of iteration may depend on the size of the input data received from Steps 358/359 above.

In some embodiments, the GBM model may ingest the output features set/profile from process 358 and/or 359 as input and perform a ten-way cross validation. In other words, each training is split into 10 chunks, each chunk is validated against the 9 other chunks. For example, the process models 9 chunks and predicts the 10th, then rotates 10 times. Validation is performed for each chunk until all 10 chunks are validated and the results are combined.

At 362-5, as the GBM model may provide multi-class classification, a multinominal accuracy procedure may be performed on the test data set portion of process 358. This is to reduce bias and variance in the model. Step 362-5 may be a predicting step. The multinomial accuracy procedure calculates the percent correct predictions for all of the classes combined. Some embodiments of this step are also described in Step 364 (FIG. 3D) above. At 362-6, hyperparameters of the data set may be adjusted to optimize the model. The hyperparameters may include external variables set before each training. These may include variables pertaining to each machine learning algorithm. For example, in Gradient Boosted Machines the variables may include the learning rate, number of trees, and tree depth. In some embodiments, all variables may be selectable. For example, the min and max number of the trees is 1 to 50. The min and max depth of the trees is 1 to 10. After some initial test runs the learning rate is set to 0.1. In some embodiments, processes 362-4 to 362-6 may be repeated, e.g., 100 times, creating 100 predictive GBM models. The process then continues at 364, back at FIG. 3D.

FIG. 3D-3 illustrates an exemplary modeling process 362 using random forest (RF) modeling to improve prediction of patterns in classification data and to improve generation of multiclass classified categories. In some embodiments, at 362-7, the RF modeling may include selecting and creating additional decision trees in the data set by selecting random samples and/or variables in the set, thus creating a “random forest.” RF modeling traverses each tree and at each node in a tree to select a certain random predictor variable from the available data set, and (with the use of an objective function) use the variable with best split before moving to the next node. The split then generates more trees which generate more results, from which the machine can learn. The model may then aggregate the predictions of the trees, for example, by selecting (voting on) the results selected by most trees.

In some embodiments, the RF model may ingest the output features set/profile from process 358 and/or 359 as input and perform a ten-way cross validation. In other words, each training is split into 10 chunks, each chunk is validated against the 9 other chunks. For example, the process models 9 chunks and predicts the 10th, then rotates 10 times. Validation is performed for each chunk until all 10 chunks are validated and the results are combined.

At 362-8, as the RF model may provide multi-class classification, a multinominal accuracy procedure may be performed on the test data set portion of process 358. This is to reduce bias and variance in the model. Step 362-7 may be a predicting step. The multinomial accuracy procedure calculates the percent correct predictions for all of the classes combined. Some embodiments of this step are also described in Step 364 (FIG. 3D) above. At 362-9, hyperparameters of the data set may be adjusted to optimize the model. The hyperparameters may include external variables set before each training. These may include variables pertaining to each machine learning algorithm. For example, in Random Forests, the variables may include the number of trees, and tree depth. In some embodiments, all variables may be selectable. For example, the min and max number of the trees is 1 to 50. The min and max depth of the trees is 1 to 10. In some embodiments, processes 362-7 to 362-9 may be repeated, e.g., 100 times, creating 100 predictive RF models. The process then continues at 364, back at FIG. 3D.

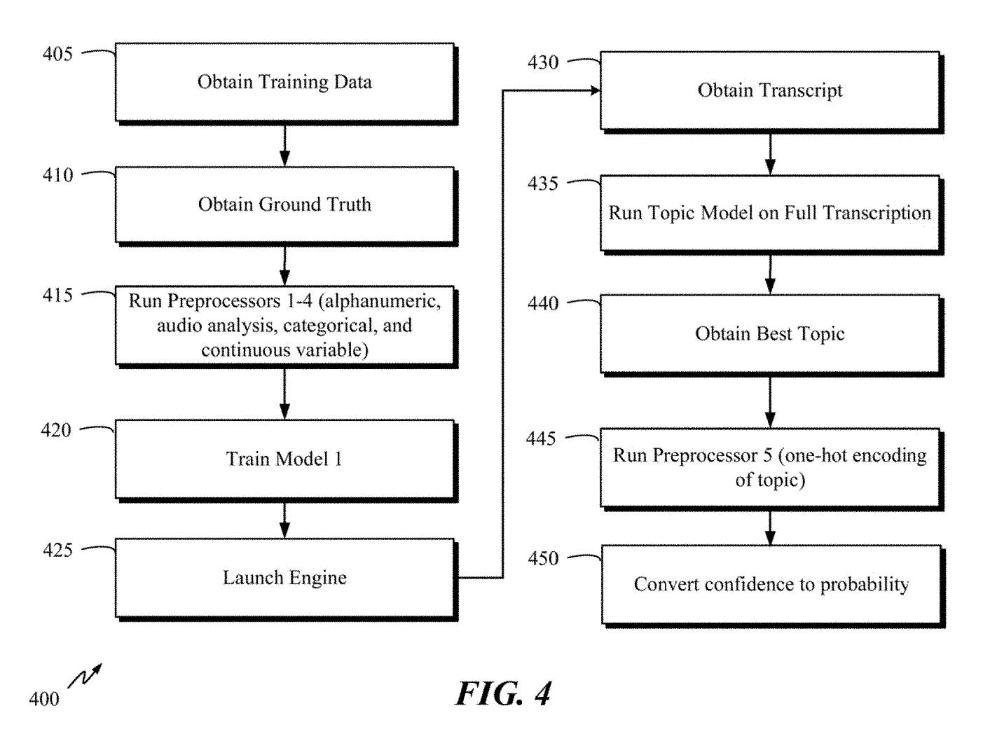

Referring to FIG. 3D-4, as mentioned above, in some embodiments, it is advantageous to combine the three machine learning algorithms/models (DLNN model, GBM model, and RF model) as shown in process 362. In these embodiments, the system may run the three models separately as described above in FIG. 3D-1, 3D-2 and 3D-3. Then at 363-4, the results from all three models (may be up to 300 models in the above example) may be combined in a multi-model stacking procedure or algorithm. At 364-4, a multinominal accuracy procedure may be performed to reduce bias and variance in the multi-model stacking. The multinomial accuracy procedure calculates the percent correct predictions for all of the classes combined. Some embodiments of this step are also described in Step 364 (FIG. 3D) above. There are several multi-model stacking algorithms for combining classification models. In some embodiments, the predictions from each model (DLNN model, GBM model, and RF model) vote to predict the best output class (i.e. best AI engine). In embodiments using more sophisticated stacking algorithms, the predictions are run through a logistic regression model which then predicts the best output class. In some other embodiments, the logistic regression model is replaced with a neural network.

At 366-4, modeling process 362 may provide a ranked list of candidate transcription engines with the highest probability of accuracy. These transcription engines may also be referred to as Artificial Intelligence engines. In some embodiments, engines may also be associated with permissions. In some exemplary implementations, a customer/user may have paid permission to use a group of engines only. If so, the highest ranked engine with the associated permission may be used for that customer.

Similarly, for the gradient boosted model 362-4 and the random forests model 362-7, a multinominal accuracy and a hyperparameter optimization processes may also be performed. The classification using the gradient boosted model 362-4 and the random forests model 362-7 may each also be repeated, e.g., 100 times, creating 100 predictive models from the gradient boosted model 362-4 and 100 predictive models from the random forests model 362-7.

At 363-4, the results from all three models (may be up to 300 models in the above example) may be combined in a multi-model stacking procedure or algorithm. At 364-4, a multinominal accuracy procedure may be performed on the validation dataset portion generated at 358 above, e.g., on the 85% combined training and testing data sets

At 366-4, modeling process 362 may provide a ranked list of candidate transcription engines with the highest predicted accuracy. These transcription engines may also be referred to as Artificial Intelligence engines. In some embodiments, engines may also be associated with permissions. In some exemplary implementations, a customer/user may have paid permission to use a group of engines only. If so, the highest ranked engine with the associated permission may be used for that customer.

It should be noted that although the above description may use examples of processing audio data, image and video data may also be processed using one or more processes described above.

### Topic Modeling

Turning now to FIG. 4 which illustrates an exemplary process 400 for training one or more transcription models using topic modeling in accordance with some embodiments of the present disclosure. A topic may be, for example, sports, documentary, romance, sci-fi, politics, legal, and so on. In some embodiments, a topic may be a cluster of words.

In some embodiments, certain portions of process 400 may have similar functions and features as described for the transcription model training above.

In some embodiments, process 400 may start at 405 where topic training data sets may be obtained from various topic data sources, for example Wikipedia. At 410, the ground truth for each of the obtained training data set may be obtained. At 415, both the output from 405 and 410 may be used as inputs to one or more preprocessors, including: an alphanumeric preprocessor, an audio analysis (MFCC) preprocessor, a continuous variable preprocessor, and a categorical preprocessor. At 420, outputs from 415 may be used to train a transcription model which is configured to output a list of candidate transcription engines. The list of candidate engines may be ranked by the predicted accuracy.

At 425, one of the engines from the list of candidate engines may be selected to generate a transcript of the obtained training data. At 430, the selected transcription engine may output a transcript and a multi-dimensional array of confidence values. Each confidence value may represent the confidence level that a segment is transcribed accurately. At 435, a topic model may be conducted on the full transcription. At 440, the best topic for a segment of the training data may be obtained. In some embodiments, a segment can be a sentence, a paragraph, a fragment of a sentence, or the entire transcript. In some embodiments, the topic identification module (at 440) may return thousands of topics for a single training data set. At 445, a one-hot-encoding preprocessor may be run on the topics returned by the topic generation model. In this way, the topic of any particular segment of the training data set may be quickly determined.

At 450, in some embodiments, the confidence value in the array returned with the selected transcription engine may be converted to probability value using a linear mapping procedure. The probability value may be used in determining whether the topic modeling is done or further processing may be performed.

Model Training using Four Preprocessors

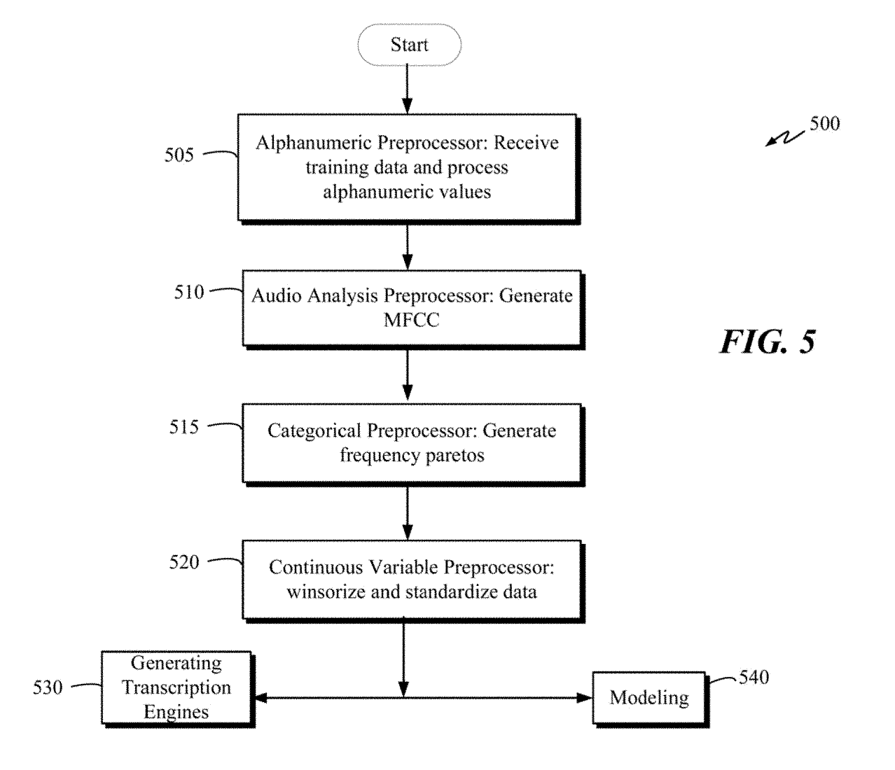

Turning to FIG. 5, a flow chart illustrates an exemplary pre-processing process 500 for conditioning one or more media files (e.g., audio data, video data, etc.) for features identification and extraction, and for training transcription models, object recognition models, including face recognition models, and/or optical character recognition models. The pre-processing process 500 may include transcribing the audio data in the one or more media files, and identifying objects of (including faces in) video data in the one or more media files. Generally, data from a media file may be preprocessed (conditioned) using four preprocessors, including an alphanumeric preprocessor, an audio analysis preprocessor, a categorical preprocessor, and a continuous variable preprocessor. In some embodiments, the order and combination of the four preprocessors are as shown. In these embodiments, it is preferred that the continuous variable preprocessor, where winsorization and standardization are performed, runs after the alphanumeric preprocessor, the audio analysis preprocessor, and the categorical preprocessor. The advantages for this combination and order of the four preprocessors may include, for example, improved computer processing efficiency, improved computer processing performances, improved prediction, improved accuracy, and better transcription engines. Details of the preprocessors are also described above with respect to FIGS. 2 and 3.

In some embodiments, one or more media files can be processed in parallel (simultaneously) by the alphanumeric preprocessor, the audio analysis preprocessor, and the categorical preprocessor. The one or more media files (media data) can include a training data set, customers' uploaded media files, ground truth transcription data, metadata, or a combination thereof.

At 505, data received from a database of media data, such as database 215 in FIG. 2B, may be ingested to an alphanumeric processor which may convert one or more features of the media data having alphanumeric values into real and integer values. For example, a media feature (which may be referred to as metadata) can be a file type (e.g., mp3, mp4, avi, way, etc.), an encoding format (e.g., H.264, H.265, AV1, etc.), or an encoding rate, etc. In this example, an mp3 file type may be assigned a value of 10 and a way file type may be assigned a value of 11, and so on. In this way, each alphanumeric-based feature can be categorized, standardized, and analyzed across many media files.

In some embodiments, this step prepares the data for one or more other preprocessors and the machine learning algorithms in the modeling process described herein which may only process numerical input values, not alphanumeric values. At this stage, a feature profile may also be generated.

At 510, data output from the alphanumeric processor where features with alphanumeric values are converted into real and integer values can be further ingested into an audio analysis preprocessor. In some embodiments, the audio analysis preprocessor may generate mel-frequency cepstral coefficients (MFCC) using the input data and functions of the MFCC including mean, min, max, median, first and second derivatives, standard deviation and variance. In some embodiments, the audio analysis preprocessor can process the media data prior to, concurrently with, or after the alphanumeric preprocessor.

The audio analysis preprocessor can use MFCC to extract, from the media data, audio features, which can then be added to the feature profile of the media data. Generally, mel-frequency cepstrum is a characterization of the power spectrum of the sound wave of the audio portion of the media data. The characterization of the power spectrum may be based on a linear cosine transform of a log power spectrum on a nonlinear mel scale of frequency. This characterization is powerful in speech processing because the frequency bands of mel-frequency cepstrum closely approximate the frequency response of the human auditory system. For non-audio types of feature extraction, the audio analysis preprocessor may be bypassed. Other types of feature extraction may include, for example, object recognition, face recognition, and optical character recognition.

At 515, combined output from the alphanumeric processor and the audio analysis preprocessor may be ingested into a categorical preprocessor which may generate frequency paretos of features in the feature profile generated by the alphanumeric preprocessor combined with the features from the audio analysis preprocessor. In some embodiments, the categorical preprocessor may analyze the feature profile of the media data, which may include features identified and/or classified by one or more of the alphanumeric and audio analysis preprocessors. The feature profile of the media data can have hundreds of features. In some embodiments, to identify key features in the media data, frequency paretos may be used to generate frequency distribution of features in the feature profile.

In some embodiments, the categorical preprocessor can process the media data prior to, concurrently with, or after the alphanumeric preprocessor and/or audio analysis preprocessor.

At 520, combined output from the alphanumeric processor, the audio analysis preprocessor and the categorical preprocessor may be ingested into a continuous variable preprocessor which may winsorize and standardize one or more continuous variables in the data. As noted above, the winsorizing or winsorization process may limit extreme values in the statistical data to reduce the effect of possibly spurious outlier values. The standardization process may rescale data so that outputs and data from the three different preprocessors above may be used more uniformly.

After 520, in some embodiments, the process 500 may continue at 530 where output from the four preprocessors may be used in generating a list of recommended transcription engines. Alternatively, after 520, the process 500 may continue at 540 where output from the four preprocessors may be used in a modeling process, from which a list of recommended transcription engines may be generated. The list of recommended transcription engines may be ranked based on predicted accuracy.

### System Architecture

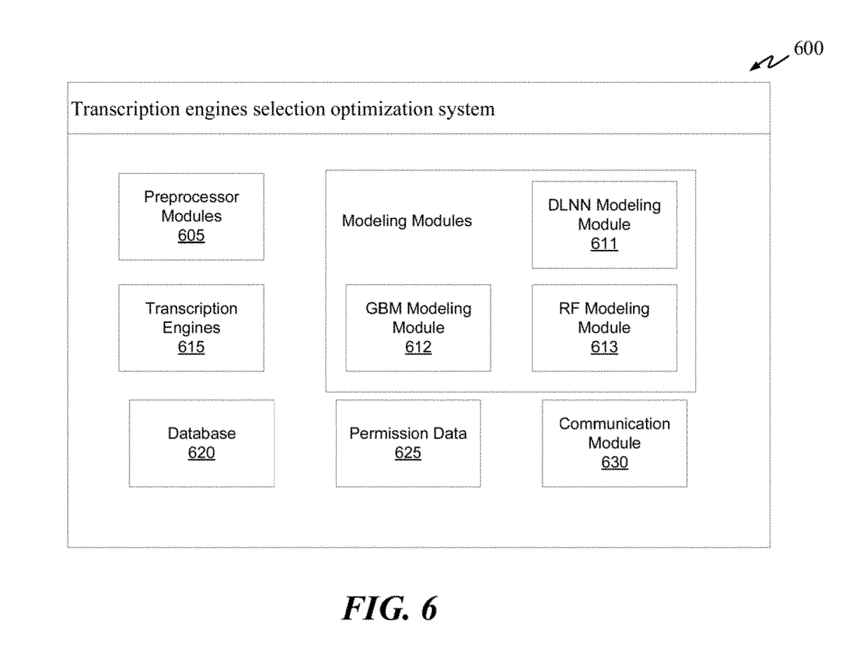

Turning to FIG. 6, a system diagram of an exemplary system 600 for optimizing the selection of transcription engines using a combination of selected preprocessors, according to some embodiments of the disclosure, is illustrated. System 600 may include a collection of preprocessor modules 605, a plurality of modeling modules (e.g., Deep Learning Neural Network (DLNN) modeling module 611, Gradient Boosted Machine (GBM) modeling module 612, and Random Forests (RF) modeling module 613), a collection of transcription engines 615, database 620, permission databases 625, and communication module 630. System 600 may reside on a single server or may be distributed. For example, one or more components (e.g., 605, 611, 612, 613, 615, etc.) of system 600 may be distributed across various locations throughout a network. Each component or module of system 600 may communicate with each other and with external entities via communication module 630. Each component or module of system 600 may include its own sub-communication module to further facilitate with intra and/or inter-system communication.

Collection of preprocessor modules 605 include algorithms and instructions that, when executed by a processor, cause the processor to perform the functions and features as described above with respect to processes 100, 200, 400, and/or process 500. In some embodiments, the preprocessor module's 605 main task includes identifying and extracting features of media data files. The one or more modeling modules 611, 612, 613 receive the features, and, using one or more machine learning models, generate a ranked list of transcription engines from which one or more engines may be selected to perform transcription of media data files. Modeling modules 611, 612, 613 include algorithms and instructions that, when executed by a processor, cause the processor to perform the functions and features as describe above with respect to processes 100, 200, 400, and 500. The selection may also be based on permissions 625 for a particular user.

In some embodiments, output data from transcription engines 615 may be accumulated in database 620 for future training of transcription engines 615. Database 620 includes media data sets which may include, for example, customers' ingested data, ground truth data, and training data.

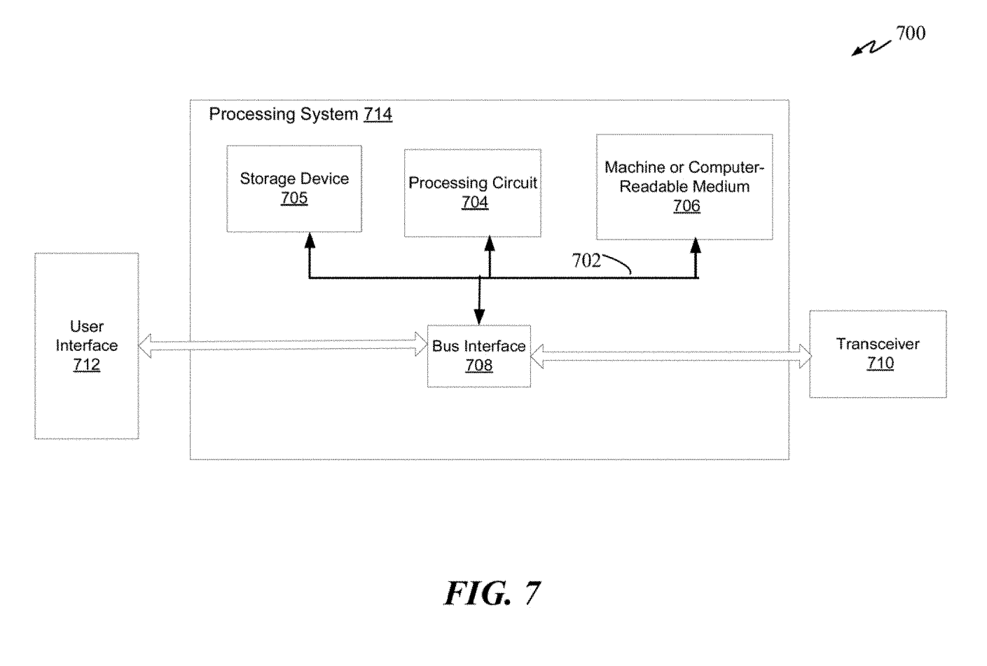

FIG. 7 illustrates an exemplary overall system or apparatus 700 in which processes 100, 200, 400, and 500 may be implemented. In accordance with various aspects of the disclosure, an element, or any portion of an element, or any combination of elements may be implemented with a processing system 714 that includes one or more processing circuits 704. Processing circuits 704 may include micro-processing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionalities described throughout this disclosure. That is, the processing circuit 704 may be used to implement any one or more of the processes described above and illustrated in FIGS. 1-5.

In the example of FIG. 7, the processing system 714 may be implemented with a bus architecture, represented generally by the bus 702. The bus 702 may include any number of interconnecting buses and bridges depending on the specific application of the processing system 714 and the overall design constraints. The bus 702 may link various circuits including one or more processing circuits (represented generally by the processing circuit 704), the storage device 705, and a machine-readable, processor-readable, processing circuit-readable or computer-readable media (represented generally by a non-transitory machine-readable medium 706). The bus 702 may also link various other circuits such as timing sources, peripherals, voltage regulators, and power management circuits, which are well known in the art, and therefore, will not be described any further. The bus interface 708 may provide an interface between bus 702 and a transceiver 710. The transceiver 710 may provide a means for communicating with various other apparatus over a transmission medium. Depending upon the nature of the apparatus, a user interface 712 (e.g., keypad, display, speaker, microphone, touchscreen, motion sensor) may also be provided.

The processing circuit 704 may be responsible for managing the bus 702 and for general processing, including the execution of software stored on the machine-readable medium 706. The software, when executed by processing circuit 704, causes processing system 714 to perform the various functions described herein for any particular apparatus. Machine-readable medium 706 may also be used for storing data that is manipulated by processing circuit 704 when executing software.

One or more processing circuits 704 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The software may reside on machine-readable medium 706. The machine-readable medium 706 may be a non-transitory machine-readable medium. A non-transitory processing circuit-readable, machine-readable or computer-readable medium includes, by way of example, a magnetic storage device (e.g., solid state drive, hard disk, floppy disk, magnetic strip), an optical disk (e.g., digital versatile disc (DVD), Blu-Ray disc), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer. The terms “machine-readable medium”, “computer-readable medium”, “processing circuit-readable medium” and/or “processor-readable medium” may include, but are not limited to, non-transitory media such as portable or fixed storage devices, optical storage devices, and various other media capable of storing, containing or carrying instruction(s) and/or data. Thus, the various methods described herein may be fully or partially implemented by instructions and/or data that may be stored in a “machine-readable medium,” “computer-readable medium,” “processing circuit-readable medium” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer.

The machine-readable medium 706 may reside in the processing system 714, external to the processing system 714, or distributed across multiple entities including the processing system 714. The machine-readable medium 706 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system.

One or more of the components, processes, features, and/or functions illustrated in the figures may be rearranged and/or combined into a single component, block, feature or function or embodied in several components, steps, or functions. Additional elements, components, processes, and/or functions may also be added without departing from the disclosure. The apparatus, devices, and/or components illustrated in the Figures may be configured to perform one or more of the methods, features, or processes described in the Figures. The algorithms described herein may also be efficiently implemented in software and/or embedded in hardware.

Note that the aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and processes have been described above generally in terms of their functionality. Whether such functionality is implemented as hardware or software depends upon the particular application and design constraints imposed on the overall system.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The enablements described above are considered novel over the prior art and are considered critical to the operation of at least one aspect of the disclosure and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described above are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

In the foregoing description and in the figures, like elements are identified with like reference numerals. The use of “e.g.,” “etc,” and “or” indicates non-exclusive alternatives without limitation, unless otherwise noted. The use of “including” or “includes” means “including, but not limited to,” or “includes, but not limited to,” unless otherwise noted.

As used above, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, processes, operations, values, and the like.

1. A system for optimizing selection of transcription engines using a combination of selected machine learning models, comprising:
a database storing one or more media data sets;
one or more preprocessors configured to generate a plurality of features from a selected media data set of the one or more media data sets;
a deep learning neural network model configured to improve detection of patterns in the plurality of features and to improve generation of classified categories;
a gradient boosted machine model configured to improve prediction of patterns in the plurality of features and to improve generation of multiclass classified categories;
a random forest model configured to improve prediction of patterns in a first classification data and to improve generation of multiclass classified categories;
a ranked list of transcription engines generated based on improvements learned from the deep learning neural network model, the gradient boosted machine model, and the random forest model; and
a transcription engine, selected from the ranked list of transcription engines, configured to ingest the plurality of features and to generate a transcript for the selected media data set.

2. The system of claim 1, wherein the one or more preprocessors include an alphanumeric preprocessor, an audio analysis preprocessor, a categorical preprocessor, and a continuous variable preprocessor.

3. The system of claim 1 further includes a topic modeling preprocessor.

4. The system of claim 1 further includes a multi-model stacking model created from a combination of results generated from the deep learning neural network model, the gradient boosted machine model and the random forest model.

5. The system of claim 1 further includes one or more multinomial accuracy modules configured to reduce bias and variance in the plurality of features.

6. The system of claim 5, wherein each of the one or more multinomial accuracy modules generates a confusion matrix.

7. The system of claim 4, wherein predictions from the deep learning neural network model, the gradient boosted machine model and the random forest model vote to predict a best transcription engine.

8. The system of claim 4, wherein predictions from the deep learning neural network model, the gradient boosted machine model and the random forest model are further processed by a logistic regression model to predict a best transcription engine.

9. The system of claim 4, wherein predictions from the deep learning neural network model, the gradient boosted machine model and the random forest model are further processed by a neural network model to predict a best transcription engine.

10. The system of claim 1, wherein the ranked list of transcription engines is based on the highest probability of accuracy.

11. A computer-implemented method for optimizing the selection of transcription engines using a combination of selected machine learning models, comprising:
one or more network-connected servers, each including a processor and non-transitory computer readable memory storing instructions that, when executed by the processor:
generate, by one or more preprocessors, a plurality of features from a selected media data set of one or more media data sets;
improve, by a deep learning neural network model, detection of patterns in the plurality of features and to improve generation of classified categories;
improve, by a gradient boosted machine model, prediction of patterns in the plurality of features and to improve generation of multiclass classified categories;
improve, by a random forest model, prediction of patterns in a first classification data and to improve generation of multiclass classified categories;
generate a ranked list of transcription engines based on improvements learned from the deep learning neural network model, the gradient boosted machine model, and the random forest model; and
select a transcription engine from the ranked list of transcription engines, configured to ingest the plurality of features and to generate a transcript for the selected media data set.

12. The method of claim 11, wherein the one or more preprocessors include an alphanumeric preprocessor, an audio analysis preprocessor, a categorical preprocessor, and a continuous variable preprocessor.

13. The method of claim 11 further includes a topic modeling preprocessor.

14. The method of claim 11 further includes a multi-model stacking model created from a combination of results generated from the deep learning neural network model, the gradient boosted machine model and the random forest model.

15. The method of claim 11 further includes one or more multinomial accuracy modules configured to reduce bias and variance in the plurality of features.

16. The method of claim 15, wherein each of the one or more multinomial accuracy modules generates a confusion matrix.

17. The method of claim 14, wherein predictions from the deep learning neural network model, the gradient boosted machine model and the random forest model vote to predict a best transcription engine.

18. The method of claim 14, wherein predictions from the deep learning neural network model, the gradient boosted machine model and the random forest model are further processed by a logistic regression model to predict a best transcription engine.

19. The method of claim 14, wherein predictions from the deep learning neural network model, the gradient boosted machine model and the random forest model are further processed by a neural network model to predict a best transcription engine.

20. The method of claim 11, wherein the ranked list of transcription engines is based on the highest probability of accuracy.
